(19) United States
(12) Patent Application Publication
(10) Pub. No.: US 2019/0068405 A1
(43) Pub. Date: Feb. 28, 2019

(54) ALLOCATING INTERNAL VLAN IDS TO USER-CONFIGURED VLANS

(71) Applicant: HEWLETT PACKARD ENTERPRISE DEVELOPMENT LP, Houston, TX (US)

(72) Inventors: Tathagata NANDY, Bangalore (IN); Krishna Mohan ELLURU, Bangalore (IN); Mahammadnaeem Karimbhai MEMON, Bangalore (IN)

(73) Assignee: HEWLETT PACKARD ENTERPRISE DEVELOPMENT LP, Houston, TX (US)

(21) Appl. No.: 16/115,144

(22) Filed: Aug. 28, 2018

(30) Foreign Application Priority Data
Aug. 31, 2017 (IN) 201741030933

(51) Int. Cl. H04L 12/46; H04L 12/931

(52) U.S. Cl. CPC H04L 12/4645; H04L 45/64; H04L 49/354; H04L 49/70

(57) ABSTRACT

According to examples, an apparatus for managing alerts pertaining to additions of users to a user group in a computer network may include a processor and a memory, which may have stored thereon machine readable instructions that are to cause the processor to, during a learning period, identify an entity that added a user to the user group during the learning period and enter an identification of the identified entity into an allowed entity list for the user group. Following the learning period, the instructions are to cause the processor to identify a user addition event that indicates that an adding entity added another user to the user group, determine whether the adding entity is in the allowed entity list, and manage issuance of an alert regarding the user addition event based upon whether the adding entity is in the allowed entity list to reduce a number of issued alerts.

### BACKGROUND

Layer 3 (L3) traffic in a switch that is capable of routing is typically transmitted through a switched virtual interface (SVI) or a route only port (ROP), which may also be considered to be a L3 port. Switch ASICs often treat an ROP and an SVI similarly by allocating an internal VLAN to the ROP. The ROP is added as an access port to the internal VLAN that is created in the ASIC with a VLAN and a single port. In this regard, when the switch performs a L3 routing across VLANs, the underlying application specific integrated circuit (ASIC) is able take the same action for SVIs and ROPs.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus for allocating an internal VLAN ID to a user-configured VLAN;

FIG. 2 shows a block diagram of an example network environment in which the apparatus depicted in FIG. 1 may be implemented;

FIGS. 3 and 4, respectively, depict flow diagrams of example methods for managing allocation of an internal VLAN ID to a user-configured VLAN;

FIG. 5A depicts a flow diagram of an example method for managing states of ROPs; and

FIG. 5B depicts a flow diagram of an example method for managing internal VLAN IDs.

### DETAILED DESCRIPTION

For simplicity and illustrative purposes, the present disclosure is described by referring mainly to embodiments. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on. A virtual local area network (VLAN) may be a broadcast domain that may be partitioned and isolated in a computer network at the data link layer. For instance, a VLAN may create the appearance and functionality of network traffic that is physically on a single network but acts as if split between separate networks. A VLAN ID may be an identifier that is assigned to a VLAN and may be inserted into a packet header to identify to which VLAN the packet belongs. For instance, a switch may use the VLAN ID in a packet to determine the port or interface in the switch to send the packet. The VLAN ID may equivalently be referenced as a VLAN tag and these terms may be used interchangeably.

An internal VLAN ID may be an VLAD ID that is designated for use internally by an application specific integrated circuit (ASIC) in a switch to create a routed port, or equivalently, a route only port (ROP). A routed port (and an ROP) may be a Layer 3 (L3) port in a switch that may be added through allocation of an internal VLAN ID created on an ASIC with a VLAN and a single port. In one regard, the use of routed ports enables the switch to perform L3 routing across VLANs, the underlying ASIC may take the same action for routed ports as switched virtual interfaces. It should be understood that routed ports and ROPs are used interchangeably throughout the present disclosure. In addition, an internal VLAN list may be a list of the internal VLAN IDs designated for ROPs in the switch. The internal VLAN IDs included in the list of internal VLAN IDs may be user-defined and may include a disparate set of VLAN ranges. That is, for instance, the internal VLAN IDs in the internal VLAN ID list need not be a consecutive range of VLAN IDs.

An ROP may be allocated with an internal VLAN ID and may thus be in an allocated state. An ROP that is not allocated with an internal VLAN ID may be considered as being in a defunct state. An ROP may also be in a shut or shut down state in which the ROP does not route any traffic. An administrator may place an ROP into the shut or shut down state or the ROP may be placed into this state as a result of a hardware and/or software failure. In addition, while in the shut or shut down state, the ROP may not consume system resources but may be allocated with an internal VLAN ID.

Each of the internal VLAN IDs may have one of a plurality of different statuses. For instance, an internal VLAN ID that is not allocated to an ROP may have an available status, an internal VLAN ID that is allocated to an ROP may have an allocated status, and an internal VLAN ID that is allocated to an ROP that is in the shut down state may have a monitored state. In other words, internal VLAN IDs having the available status may be included in an available set, internal VLAN IDs having the allocated status may be included in an allocated set, and internal VLAN IDs having the monitored state may be included in a monitored set. The internal VLAN IDs may be grouped according to the set to which they belong and this information may be included in a lookup table. In addition, the statuses of the internal VLAN IDs may be modified as the allocations of the internal VLAN IDs are modified.

Disclosed herein are apparatuses and methods for allocating an internal VLAN ID to a user-configured VLAN (e.g., a user-configured L2 VLAN). Particularly, the apparatuses and methods disclosed herein pertain to allocating an internal VLAN ID to a user-configured VLAN in instances in which the internal VLAN ID is allocated to an ROP. In addition, the internal VLAN ID may be deallocated from the ROP and allocated to the user-configured VLAN without requiring that the ROP or the switch be shutdown and restarted. Moreover, the ROP may be allocated with an available unallocated internal VLAN ID, with an internal VLAN ID of another ROP, etc. Generally speaking, another internal VLAN ID may be selected for the ROP such that disruption to the traffic switching through the switch may be minimized. For instance, an available unallocated internal VLAN ID may be selected over other allocated internal VLAN IDs. In addition, an internal VLAN ID that is allocated to an ROP having a lower priority may be selected over an internal VLAN ID that is allocated to an ROP having a higher priority. A user may set policies that define the priority levels of the ROPs as well as the order in which the internal VLAN IDs may be allocated to the ROPs.

L3 ports (ROPs) in switches are typically used for L3 transmission (e.g., inter-VLAN routing). The internal VLAN IDs may be a subset of the range of VLAN IDs used in a network and may be designated for the L3 ports. As such, the internal VLAN IDs may reduce the total number of VLAN IDs available to users to configure L2 VLANs. There may arise instances in which a user wants to use an internal VLAN ID that is assigned to an L3 port for a user-configured VLAN. As there is typically a finite range of VLANs (e.g., in the 1K-4K range), a technical problem may be that when users want to use an internal VLAN ID for a user-configured VLAN, conventionally, the port allocated to that internal VLAN ID is shut down in order for that internal VLAN ID to be allocated to the user-configured VLAN, which may result in disrupted or lost traffic through the switch.

The apparatuses and methods disclosed herein pertain to allowing users to configure VLANs using internal VLAN IDs (e.g., VLAN IDs designated for ROPs) of a switch without significantly disrupting network traffic through the switch. Particularly, through implementation of the methods and apparatuses disclosed herein, the internal VLAN ID of an ROP may be allocated to the user-configured VLAN and an attempt may be made to allocate another internal VLAN ID to the ROP. In addition, the ROP may be allocated with the other internal VLAN ID prior to the internal VLAN ID being deallocated so that switching through the ROP may not be disrupted. In other words, user-configured L2 VLANs may be allocated with internal VLAN IDs without significantly disrupting the flow of traffic through a switch. In this regard, the apparatuses and methods disclosed herein may result in the technical improvement of permitting a larger number of VLAN IDs to be used for user-configured VLANs without disrupting traffic flow through a switch, which may increase the data traffic flow through a network of which the switch is a member.

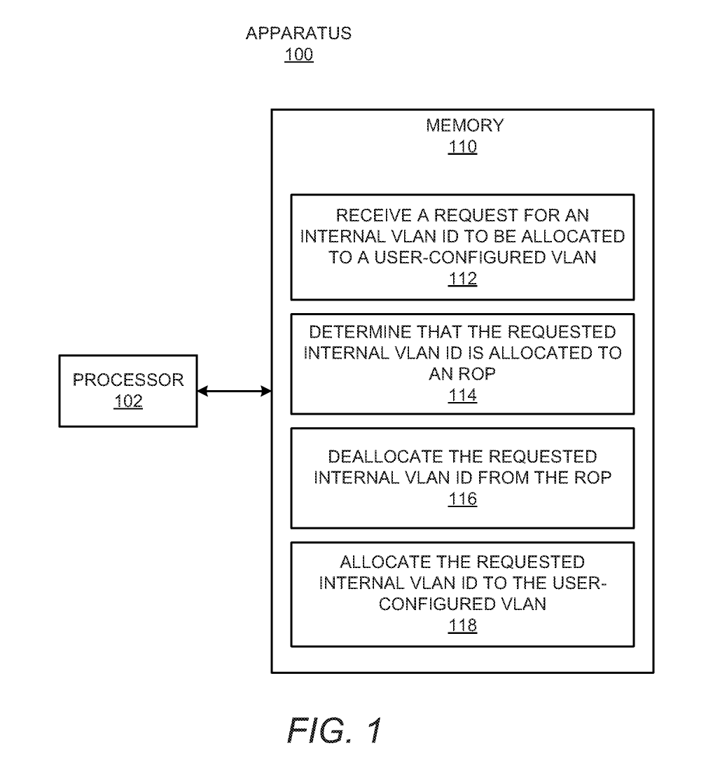

With reference first to FIG. 1, there is shown a block diagram of an example apparatus 100 for allocating an internal VLAN ID to a user-configured VLAN. It should be understood that the apparatus 100 depicted in FIG. 1 may include additional components and that some of the components described herein may be removed and/or modified without departing from a scope of the apparatus 100.

According to examples, the apparatus 100 may be a computing device such as a server, a personal computer, a laptop computer, or the like. In addition or in other examples, the apparatus 100 may be a switch, or equivalently, a network switch. In any regard, as shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device.

The apparatus 100 may also include a memory 110 that may have stored thereon machine readable instructions 112-118 (which may also be termed computer readable instructions) that the processor 102 may execute. The memory 110 may be an electronic, magnetic, optical, or other physical storage device that contains or stores executable instructions. The memory 110 may be, for example, Random Access memory (RAM), an Electrically Erasable Programmable Read-Only Memory (EEPROM), a storage device, an optical disc, and the like. The memory 110, which may also be referred to as a computer readable storage medium, may be a non-transitory machine-readable storage medium, where the term “non-transitory” does not encompass transitory propagating signals.

The processor 102 may fetch, decode, and execute the instructions 112 to receive a request for an internal VLAN ID to be allocated to a user-configured VLAN. As discussed herein, the internal VLAN ID may be included in a list of internal VLAN IDs that are designated for ROPs. The processor 102 may fetch, decode, and execute the instructions 114 to determine that the requested internal VLAN ID is allocated to an ROP. In response to the determination that the requested internal VLAN ID is allocated to an ROP, the processor 102 may fetch, decode, and execute the instructions 116 to deallocate the requested internal VLAN ID from the ROP. In addition, the processor 102 may fetch, decode, and execute the instructions 118 to allocate the requested internal VLAN ID to the user-configured VLAN.

Various additional manners in which the processor 102 may manage the allocation of internal VLAN IDs are discussed in greater detail herein below.

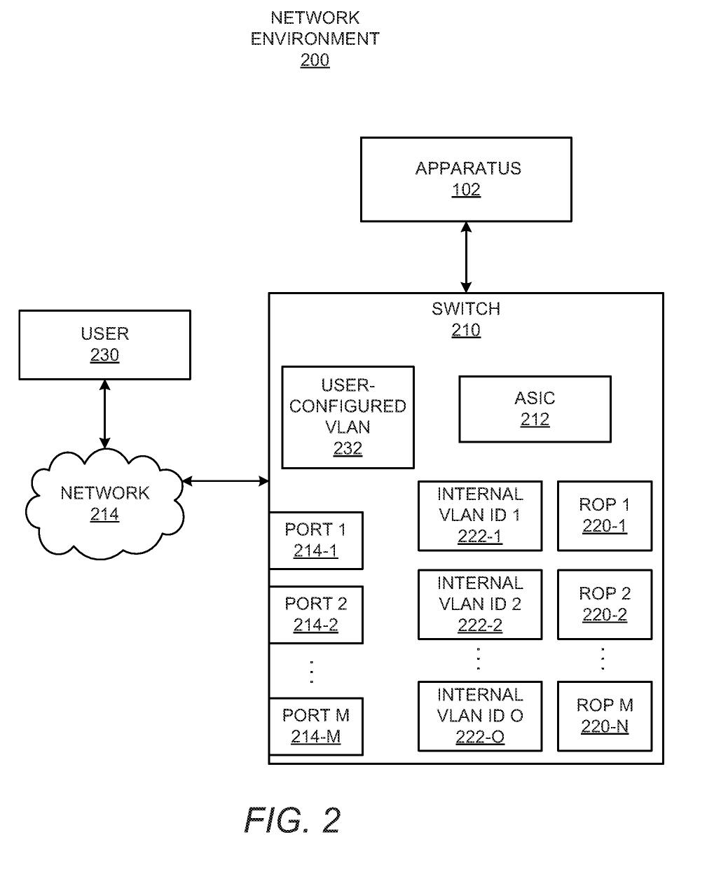

Turning now to FIG. 2, there is shown a block diagram of an example network environment 200 in which the apparatus 100 depicted in FIG. 1 may be implemented. It should be understood that the network environment 200 depicted in FIG. 2 may include additional components and that some of the components described herein may be removed and/or modified without departing from a scope of the network environment 200.

As shown in FIG. 2, the network environment 200 may include a switch 210 that is to route L3 traffic. The switch 210 may include an application specific integrated circuit (ASIC) 212 that may perform switching operations in the switch 210. The switch 210 may also include a plurality of ports 214-1 to 214-M through which the switch 210 may send and receive packets, in which the variable “M” may represent an integer greater than one. In operation, when a packet is received through a port 214-1, the ASIC 212 may determine an output port 214-2 to which the packet is to be routed. The ASIC 212 may analyze data in the packet header to identify the output port 214-2 to which the received packet is to be forwarded. For instance, the packet header data may include a VLAN ID to which the packet is a member and the ASIC 212 may identify the output port 214-2 from the VLAN ID. In instances in which the received packet is a L2 packet, the ASIC 212 may forward the packet to the identified output port 214-2.

As also shown in FIG. 2, the switch 210 may include ROPs 220-1 to 220-N, in which the variable “N” may represent an integer greater than one. The ROPs 220-1 to 220-N may be physical ports on the switch 210 that may not be associated with a single VLAN. In addition, the ASIC 212 may take similar actions as SVIs on the RIPs 220-1 to 220-N when performing L3 switching across VLANS.

As further shown in FIG. 2, a plurality of internal VLANs 222-1 to 222-O may be designated for the switch 210, in which the variable “N” may represent an integer greater than one. The internal VLAN IDs 222-1 to 222-O may a subset of the entire VLAN range that may be used in the network environment 200. By way of example, the entire VLAN range used in the network environment 200 may include VLAN IDs ranging from 0-4095 and the internal VLAN IDs 222-1 to 222-O may be a subset of that range of VLAN IDs. The internal VLAN IDs 222-1 to 222-O may be a set of consecutive VLAN IDs in the range of VLAN IDs or may be sets of multiple disparate sets of VLAN IDs in the range of VLAN IDs. In any regard, the internal VLAN IDs 222-1 to 222-O may be user-defined, for instance, an administrator may designate the internal VLAN IDs during an initial and/or an updated configuration of the switch 210.

Each of the internal VLAN IDs 222-1 to 222-O may be in one of a number of sets. The sets may include an available set, a monitored set, and an allocated set. The internal VLAN IDs in the allocated set may be those internal VLAN IDs that are allocated to ROPs 220-1 to 220-N. The internal VLAN IDs in the available set may be those internal VLAN IDs that are available to be allocated to an ROP 220-1, e.g., those internal VLAN IDs that are not currently allocated to an ROP. The internal VLAN IDs in the monitored set may be those internal VLAN IDs that are allocated to ROPs that are currently in an administrative shut down mode. In various instances in time, any of the sets may be empty, e.g., all of internal VLAN IDs 222-1 to 222-O may be allocated to the ROPs 220-1 to 220-N, none of the internal VLAN IDs may be in the monitored set, etc. As discussed herein, the internal VLAN IDs may be moved from one set to another as the allocations of the internal VLAN IDs vary. The internal VLAN IDs may be moved according to policies, e.g., an internal VLAN ID in the monitored set may be moved to the available after being in the monitored set for a certain period of time.

There may arise instances in which a user 230 may seek to have an internal VLAN ID of the switch 210 allocated to a user-configured VLAN 232. These instances may arise because there may be a finite number of VLAN IDs that may be used in the network environment 200, and thus, for example, a VLAN ID outside of the list of internal VLAN IDs 222-1 to 222-O may not be available for the user to allocate to the user-configured VLAN 232. In other instances, a VLAN ID outside of the list of internal VLAN IDs 222-1 to 222-O may be available, but the user 230 may still seek to allocate an internal VLAN ID 222-1 to the user-configured VLAN 232.

In any regard, and as shown in FIG. 2, the user 230 may submit, via a network 214, a request for an internal VLAN ID to be allocated to the user-configured VLAN 232. For instance, the user 230 may submit the request as part of the configuration of the user-configured VLAN 232. The network 214 may be a local area network, a wide area network, the Internet, or the like. According to examples, the apparatus 102 may receive this request and may grant the request. For instance, if the requested internal VLAN ID is in the available set, the apparatus 102 may allocate the requested internal VLAN ID to the user-configured VLAN 232. Additionally, if the requested internal VLAN ID is in the allocated set or in the monitored set, the apparatus 102 may still allocate the requested internal VLAN ID to the user-configured VLAN 232, but may perform additional operations as discussed herein.

In the example depicted in FIG. 2, the apparatus 102 may be a computing device that is separate from the switch 210. In this example, the apparatus 102 may be a server or other computing device that may communicate with the switch 210 via the network 214 or via another communication medium, such as via a direct wired or wireless communication channel. In other examples, the apparatus 102 may be integrated with the switch 210, e.g., the switch 210 may implement some or all of the functions of the apparatus 102 disclosed herein.

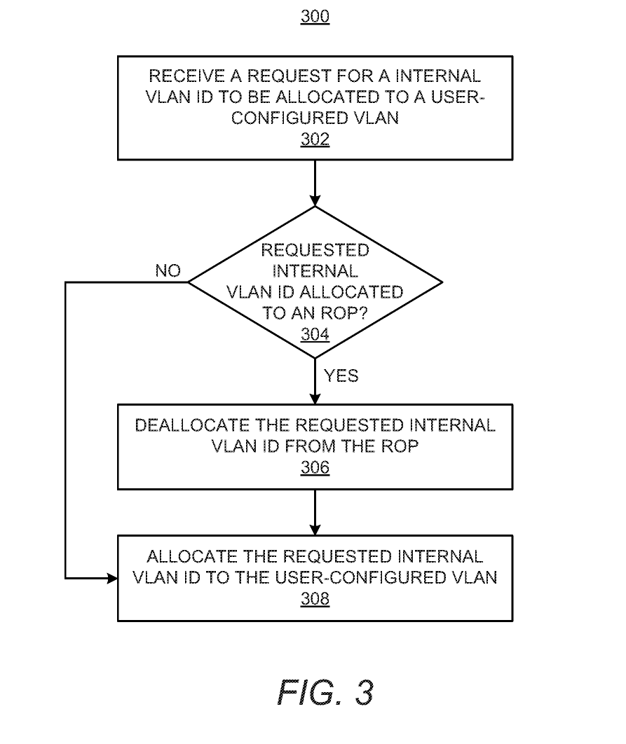

Turning now to FIGS. 3-5B, there are respectively shown flow diagrams of example methods 300, 400, 500, and 510 for managing allocation of an internal VLAN ID 220-1 to a user-configured VLAN 232. It should be understood that the methods 300, 400, 500, and 510 depicted in FIGS. 3-5B may include additional operations and that some of the operations described therein may be removed and/or modified without departing from scopes of the methods 300, 400, 500, and 510. The descriptions of the methods 300, 400, 500, and 510 are also made with reference to the features depicted in FIGS. 1 and 2 for purposes of illustration. For instance, the processor 102 of the apparatus 100 may execute machine readable instructions to implement the some or all of the methods 300, 400, 500, and 510.

With reference first to FIG. 3, at block 302, the processor 102 may receive a request for an internal VLAN ID 222-1 to be allocated to a user-configured VLAN 232. As noted elsewhere herein, the internal VLAN ID 222-1 may be included in the plurality of internal VLAN IDs 222-1 to 222-O that are designated for the ROPs 220-1 to 220-N in the switch 210.

At block 304, the processor 102 may determine whether the requested internal VLAN ID 222-1 is currently allocated to an ROP 220-1. That is, the processor 102 may determine whether the ASIC 212 is performing switching action on any of the ROPs using the requested internal VLAN ID 222-1. The processor 102 may maintain identifications of internal VLAN IDs 222-1 to 222-O allocations to the ROPs 220-1 to 220-N, for instance, in a lookup table in a data store (not shown). Thus, for instance, the processor 102 may determine whether the requested internal VLAN ID 222-1 is allocated to an ROP 220-1 from the lookup table. An internal VLAN ID may be considered as being allocated to an ROP when the ROP performs switching operations on data packets using that internal VLAN ID. In addition, an internal VLAN ID may be allocated to a single ROP at a time, but may be re-allocated to another ROP.

According to examples, the processor 102 may input statuses of the internal VLAN IDs 222-1 to 222-O into the lookup table. That is, for instance, the processor 102 may indicate whether the internal VLAN IDs 222-1 to 222-O are part of an available set, a monitored set, or an allocated set. The processor 102 may also update the lookup table as the statuses of the internal VLAN IDs 222-1 to 222-O change. The processor 102 may thus determine whether the requested internal VLAN ID is allocated to an ROP based upon the status of the internal VLAN ID 222-1 as identified in the lookup table. That is, the processor 102 may determine that the internal VLAN ID 222-1 is allocated to an ROP 220-1 in response to the status of the internal VLAN ID 222-1 being identified as being in the allocated set or in the monitored set. Likewise, the processor 102 may determine that the internal VLAN ID 222-1 is not allocated to an ROP in response to the status of the internal VLAN ID 222-1 being identified as being in the available set.

In other examples, the processor 102 may determine that the internal VLAN ID 222-1 is allocated to an ROP 220-1 in response to the lookup table indicating that the internal VLAN ID 222-1 is allocated to the ROP 220-1 or that the internal VLAN ID 222-1 is not allocated to an ROP 220-1 in response to the lookup table indicating that the internal VLAN ID 222-1 is not allocated to any of the ROPs 220-1 to 220-N.

In any regard, in response to a determination at block 304 that the requested internal VLAN ID 222-1 is allocated to an ROP 220-1, the processor 102 may deallocate the requested internal VLAN ID 222-1 from the ROP 220-1 as indicated at block 306. In addition, the processor 102 may allocate the requested internal VLAN ID 222-1 to the user-configured VLAN 232. That is, the processor 102 may program the ASIC 212 such that the user-configured VLAN 232 uses the internal VLAN ID 222-1.

With reference back to block 304, in response to a determination that the requested internal VLAN ID 222-1 is not allocated to an ROP, the processor 102 may allocate the requested internal VLAN ID 222-1 to the user-configured VLAN 232 as indicated at block 308. That is, the processor 102 may allocate the requested internal VLAN ID 222-1 to the user-configured VLAN 232 without deallocating the requested internal VLAN ID 222-1 from an ROP.

According to examples, the processor 102 may allocate the requested internal VLAN ID 222-1 to the user-configured VLAN 232 without shutting down an ROP. That is, for instance, even when the requested internal VLAN ID 222-1 is allocated to an ROP 220-1, the processor 102 may allocate the requested internal VLAN ID 222-1 to the user-configured VLAN 232 and may deallocated the internal VLAN ID 222-1 from the ROP 220-1 without shutting down the ROP 220-1.

Turning now to FIG. 4, at block 402, the processor 102 may receive a request for an internal VLAN ID 222-1 to be allocated to a user-configured VLAN 232. As noted elsewhere herein, the internal VLAN ID 222-1 may be included in the plurality of internal VLAN IDs that are designated for the ROPs 220-1 to 220-N. In addition, at block 404, the processor 102 may determine whether the requested internal VLAN ID 222-1 is currently allocated to an ROP 220-1. The processor 102 may make the determination at block 404 in any of the manners discussed above with respect to block 304 in FIG. 3. In response to a determination that the requested internal VLAN ID 222-1 is not allocated to an ROP 220-1, at block 406, the processor 102 may allocate the requested internal VLAN ID to the user-configured VLAN 232.

However, in response to a determination that the requested internal VLAN ID 222-1 is allocated to an ROP 220-1, at block 408, the processor 102 may determine whether an unallocated internal VLAN ID is available. That is, for instance, the processor 102 may determine whether there are any internal VLAN IDs listed in the available set of internal VLAN IDs. In response to a determination that an unallocated internal VLAN ID 220-2 is available at block 408, the processor 102 may allocate the unallocated internal VLAN ID 220-2 to the ROP 220-1 as indicated at block 410. In addition, at block 412, the processor 102 may deallocate the internal VLAN ID from the ROP 220-1 and may allocate the requested internal VLAN ID to the user-configured VLAN (block 406).

In one regard, the processor 102 may allocate the unallocated internal VLAN ID 222-2 to the ROP 220-1 at block 410 while the requested internal VLAN ID 222-1 is also allocated to the ROP 220-1. Thus, for instance, the ROP 220-1 may concurrently be allocated with multiple VLAN IDs 222-1 and 222-2 for a period of time prior to the requested internal VLAN ID 222-1 being deallocated from the ROP 220-1. In other words, the ROP 220-1 may be allocated to two internal VLAN IDs prior to the internal VLAN ID 222-1 being deallocated from the ROP 220-1. As a result, the ROP 220-1 may continue to switch traffic with minimal or no disruption during the transition in the allocation of the internal VLAN ID 222-1 to the user-configured VLAN 232.

In response to a determination at block 408 that an unallocated internal VLAN ID is not available, the processor 102 may access policy information regarding the ROPS 220-1 to 220-N. That is, the processor 102 may access policy information regarding the respective priorities of the ROPs 220-1 to 220-N. The policy information may indicate, for instance, that the ROPs 220-1 to 220-N may have different policies with respect to each other or may be grouped into different priority classes. Thus, by way of example, one of the ROPs 220-1 may have a higher priority level than another one of the ROPs 220-2. The policy information may also include additional types of policies, such as, for instance, policies pertaining to moving inactive ROPs to a defunct state and moving ROPs that are in a defunct state to an active state. The processor 102 may apply the policies to, for instance, identify which of the ROPs in the defunct state have the highest priority levels and may move those ROPs to the active state prior to moving other ones of the ROPs to the active state. In any regard, the policies in the policy information may be user defined, e.g., may be defined by an administrator, a user, etc. The policies may also be policies that may be applied to multiple switches in a network.

According to examples, based upon the policy information, and in response to a determination at block 408 that an unallocated internal VLAN ID is not available, the processor 102 may determine whether there is a lower priority ROP 220-2 that has been allocated an internal VLAN ID 222-2 at block 414. In addition or in other examples, the processor 102 may determine at block 414 whether there is an idle ROP 220-3 that has been allocated an internal VLAN ID 222-2 at block 414. In examples, the processor 102 may determine whether there is an idle ROP 220-3 prior to determining whether there is a lower priority ROP 220-2. An idle ROP 220-3 may be an ROP 220-3 that has switched traffic at below a predefined level for at least a predefined period of time. For instance, an ROP 220-3 may be deemed to be idle if the ROP 220-3 has not switched traffic for at least a predefined period of time, e.g., for about 10 minutes, for about 15 minutes, etc. As another example, an ROP 220-3 may be deemed to be idle if the ROP 220-3 has switched a relatively small amount of traffic for predefined period of time. In any regard, the predefined level and the predefined period of time may be user-defined.

According to examples, the processor 102 may identify the idle/lower priority ROPs that have been allocated internal VLAN IDs that are included in the monitored set of VLAN IDs. That is, for instance, the processor 102 may identify an internal VLAN ID that is allocated to an ROP that is currently shutdown. In addition, the processor 102 may select the internal VLAN ID in the monitored set that is allocated to an ROP having the lowest priority level, e.g., may select the internal VLAN ID allocated to an ROP in the monitored set having the lowest priority level. Thus, for instance, the processor 102 may prioritize the internal VLAN ID to be allocated to the ROP 220-1 to minimize disruption of traffic flow through the switch 210.

In response to a determination that an idle ROP 220-3 and/or that there is a lower priority ROP 220-2, at block 416, the processor 102 may deallocate the internal VLAN ID 222-2 from the idle/lower priority ROP. The processor 102 may also or in other examples, deallocate the internal VLAN ID 222-2 from an ROP that is currently under an administrative shutdown. In any regard, at block 418, the processor 102 may allocate the internal VLAN ID 222-2 that has been deallocated from the idle/lower priority/shutdown ROP to the ROP 220-1. Moreover, at block 420, the internal VLAN ID 220-1 may be deallocated from the ROP 220-1. Similarly to the discussion presented above with respect to block 410, the ROP 220-1 may be allocated with both the requested internal VLAN ID 222-1 and the other internal VLAN 222-2 to prevent or minimize disruption of the ROP 220-1 in switching traffic. In any regard, the processor 102 may allocate the requested internal VLAN ID 222-1 to the user-configured VLAN 232 as indicated at block 406.

With reference back to block 414, in response to a determination that an idle/lower priority/shutdown ROP is not present, the processor 102 may deallocate the internal VLAN ID 222-1 from the ROP 220-1 as indicated at block 422. In addition, the processor 102 may designate the ROP 220-1 as being in a defunct state (as indicated at block 424), e.g., that an internal VLAN ID is not allocated to the ROP 220-1 and is thus unable to perform traffic switching in the switch 210. The processor 102 may further allocate the requested internal VLAN ID 222-1 to the user-configured VLAN 232 as indicated at block 406.

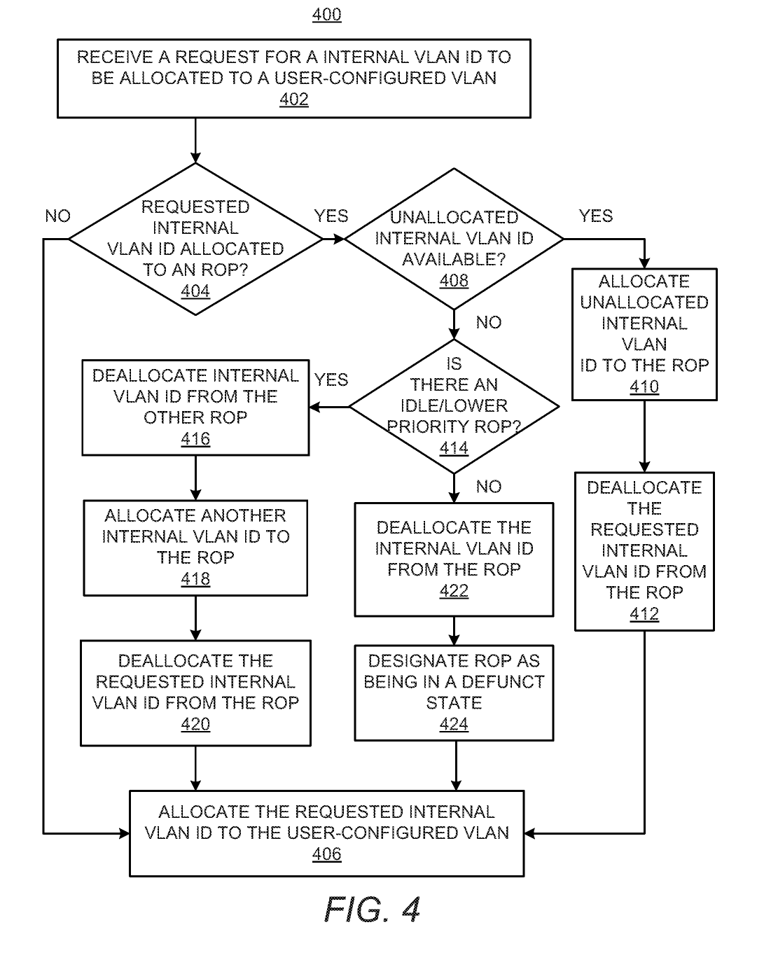

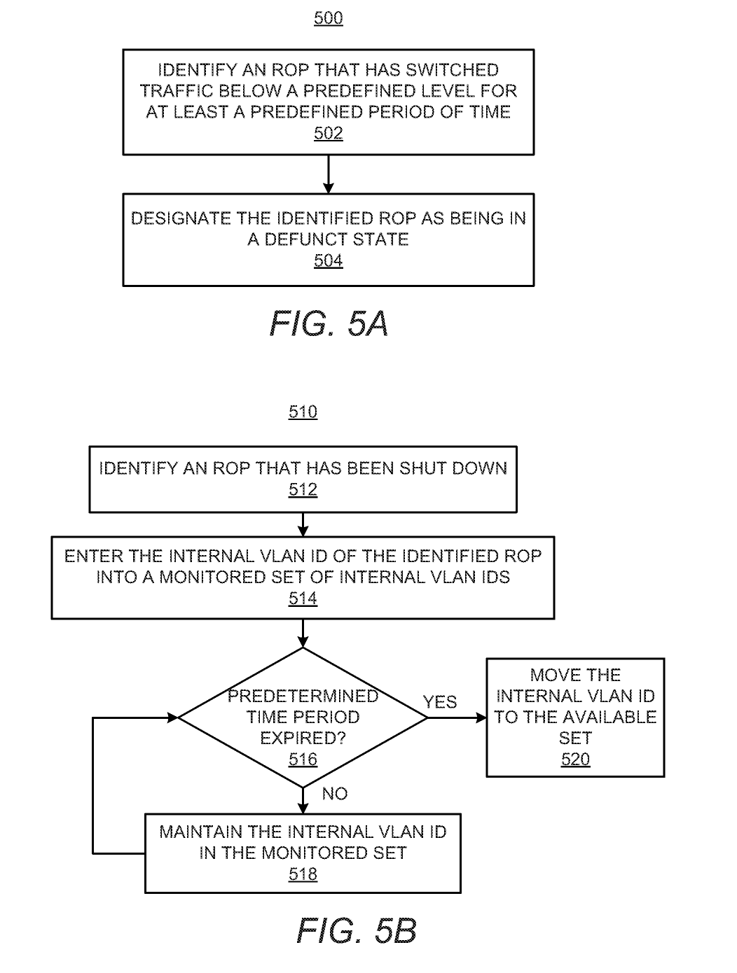

Turning now to FIGS. 5A and 5B, there are respectively shown a flow diagram of a method 500 for managing states of ROPs 220-1 to 220-N and a flow diagram of a method 510 for managing internal VLAN IDs. That is, the processor 102 may execute the method 500 to designate inactive ROPs as being in a defunct state and the processor 102 may execute the method 510 to designate internal VLANs of ROPs that have been shutdown as either being in a monitored set or an available set.

With reference first to FIG. 5A, at block 502, the processor 102 may identify an ROP that has switched traffic below a predefined level for at least a predefined period of time. For instance, an ROP may be deemed to have switched traffic below a predefined level for at least a predefined period of time if the ROP has not been used to switch traffic for the predefined period of time or if the ROP has been used to switch a relatively small amount of traffic for the predefined period of time. In response to a determination that identified ROP has switched traffic below the predefined level for at least the predefined period of time, the processor 102 may designate the identified ROP as being in a defunct state as indicated at block 504. By designating the identified ROP as being in a defunct state, when a request to allocate the internal VLAN ID of another ROP to a user-configured VLAN is received, the internal VLAN ID of the identified ROP may be allocated to the other ROP prior to the internal VLAN ID of an ROP that is not designated as being in the defunct state.

Turning now to FIG. 5B, at block 512, the processor 102 may identify that an ROP has been shut down. The ROP may be shut down by an administrator and/or may be shut down due to a hardware and/or software failure. At block 514, the processor 102 may enter the internal VLAN ID of the identified ROP into a monitored set of internal VLAN IDs. In addition, at block 516, the processor 102 may determine whether a predetermined time period has expired that the internal VLAN ID has been entered into the monitored set. The predetermined time period may be a user-defined period of time.

In response to a determination that the predetermined time period has not expired, the processor 102 maintain the internal VLAN ID in the monitored set at block 518. The processor 102 may repeat blocks 516 and 518 until the processor 102 determines that the predetermined time period has expired at block 516. In response to a determination that the predetermined time period has expired, the processor 102 may move the internal VLAN ID of the identified ROP from the monitored set to the available set at block 520. As such, for instance, the internal VLAN ID of an ROP that has been shutdown for a period of time may be made available for allocation to another ROP, for instance, when the other ROP is configured and/or when the internal VLAN ID of the other ROP is to be allocated to a user-configured VLAN.

Some or all of the operations set forth in the methods 300, 400, 500, and 510 may be contained as utilities, programs, or subprograms, in any desired computer accessible medium. In addition, the methods 300, 400, 500, and 510 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine readable instructions that are to cause the processor to:
receive a request for an internal virtual local area network identifier (VLAN ID) to be allocated to a user-configured VLAN, the requested internal VLAN ID being included in a list of internal VLAN IDs designated for route only ports (ROPs);
determine that the requested internal VLAN ID is allocated to an ROP; and
in response to a determination that the requested internal VLAN ID is allocated to an ROP,
deallocate the requested internal VLAN ID from the ROP; and
allocate the requested internal VLAN ID to the user-configured VLAN.

2. The apparatus according to claim 1, wherein the instructions are further to cause the processor to:
determine whether an unallocated internal VLAN ID is available;
in response to a determination that an unallocated internal VLAN ID is available, allocate the available unallocated internal VLAN ID to the ROP; and
in response to a determination that an unallocated internal VLAN ID is not available, designate the ROP as being in a defunct state.

3. The apparatus according to claim 1, wherein the instructions are further to cause the processor to:
determine that an unallocated internal VLAN ID is not available;
in response to a determination that an unallocated internal VLAN ID is not available,
identify another ROP that has not switched traffic for at least a predefined period of time;
deallocate an internal VLAN ID from the other ROP; and
allocate the internal VLAN ID that is deallocated from the other ROP to the ROP.

4. The apparatus according to claim 1, wherein the instructions are further to cause the processor to:
determine that an unallocated internal VLAN ID is not available;
in response to a determination that an unallocated internal VLAN ID is not available,
identify another ROP having a lower priority than the ROP;
deallocate an internal VLAN ID from the identified other ROP having the lower priority; and
allocate the internal VLAN ID that is deallocated from the identified other ROP to the ROP.

5. The apparatus according to claim 1, wherein the apparatus includes a plurality of ROPs, and wherein the instructions are further to cause the processor to:
identify an ROP in the plurality of ROPs that has switched traffic below a predefined level for at least a predefined period of time; and
designate the identified ROP is being in a defunct state.

6. The apparatus according to claim 5, wherein the instructions are further to cause the processor to:
deallocate an internal VLAN ID from the identified ROP; and
allocate the internal VLAN ID that is deallocated from the identified ROP to the ROP.

7. The apparatus according to claim 1, wherein the apparatus includes a plurality of ROPs, and wherein the instructions are further to cause the processor to:
identify an ROP of the plurality of ROPs that has been shut down;
enter an internal VLAN ID of the identified ROP into a monitored set of internal VLAN IDs;
maintain the internal VLAN ID of the identified ROP in the monitored set in response to the identified ROP remaining shut down; and
after a predetermined period of time of the identified ROP remaining shut down, move the internal VLAN ID of the identified ROP to an available set of internal VLAN IDs.

8. The apparatus according to claim 1, wherein the instructions are further to cause the processor to:
allocate another internal VLAN ID to the ROP prior to deallocating the requested internal VLAN ID from the ROP.

9. A method comprising:
receiving a request for an internal virtual local area network identifier (VLAN ID) to be allocated to a user-configured VLAN, the requested internal VLAN ID being included in a list of internal VLAN IDs designated for routed ports in a switch;
determining that the requested internal VLAN ID is allocated to a routed port in the switch;
deallocating, by a processor, the requested internal VLAN ID from the routed port; and
allocating, by the processor, the requested internal VLAN ID to the user-configured VLAN.

10. The method according to claim 9, further comprising:
determining that an unallocated internal VLAN ID in the list of internal VLAN IDs is available; and
in response to the determination that an unallocated internal VLAN ID is available, allocating the unallocated internal VLAN ID to the routed port.

11. The method according to claim 9, further comprising:
determining that an unallocated internal VLAN ID in the list of internal VLAN IDs is not available; and
in response to the determination that an unallocated internal VLAN ID is not available,
identifying another internal VLAN ID that is currently allocated to another routed port;
deallocating the other internal VLAN ID from the other routed port; and
allocating the other internal VLAN ID to the routed port.

12. The method according to claim 9, wherein the switch includes a plurality of routed ports, the method further comprising:
identifying a routed port of the plurality of routed ports that has been shut down;
moving an internal VLAN ID of the identified routed port to a monitored set of internal VLAN IDs;
maintaining the internal VLAN ID of the identified routed port in the monitored set in response to the identified routed port remaining shut down; and
after a predetermined period of time of the identified route port remaining shut down, moving the internal VLAN ID of the identified routed port to an available set of internal VLAN IDs.

13. The method according to claim 12, further comprising:
allocating an internal VLAN ID from the available set of internal VLAN IDs to create a new routed port.

14. A non-transitory computer readable medium on which is stored machine readable instructions that when executed by a processor are to cause the processor to:
receive a request for allocation of an internal virtual local area network identifier (VLAN ID) to a user-configured VLAN, the requested internal VLAN ID being included in a list of internal VLAN IDs designated for routed ports in a switch;
determine that the requested internal VLAN ID is allocated to a routed port in the switch;
deallocate the requested internal VLAN ID from the routed port;
attempt to allocate an internal VLAN ID that is unallocated to a routed port to the routed port; and
allocate the requested internal VLAN ID to the user-configured VLAN without shutting down the routed port.

15. The non-transitory computer readable medium according to claim 14, wherein to attempt to allocate another internal VLAN ID to the routed port, the instructions are further to cause the processor to one of:
in response to a determination that the other internal VLAN ID is available, allocate the other internal VLAN ID to the routed port;
in response to a determination that another internal VLAN ID is not available,
identify, based upon a policy, another internal VLAN ID that is currently allocated to another routed port;
deallocate the other internal VLAN ID from the other routed port; and
allocate the other internal VLAN ID to the routed port; or
in response to a determination that another internal VLAN ID is not available, designate the routed port as being in a defunct state.
